(19) United States
(12) Patent Application Publication
(10) Pub. No.: US 2026/0319074 A1
(43) Pub. Date: Oct. 15, 2026

(54) OPTICAL SCANNER SYSTEM FOR LIDAR AND LIDAR

(71) Applicant: HESAI TECHNOLOGY CO, LTD., Shanghai (CN)

(72) Inventors: Qingyu XU, Shanghai (CN); Na LI, Shanghai (CN); Tianjie QIAO, Shanghai (CN); Li LI, Shanghai (CN); Xuezhou ZHU, Shanghai (CN); Shaoqing XIANG, Shanghai (CN)

(73) Assignee: HESAI TECHNOLOGY CO, LTD., Shanghai (CN)

(21) Appl. No.: 19/691,985

(22) Filed: May 29, 2026

Related U.S. Application Data
(63) Continuation of application No. PCT/CN2024/135283, filed on Nov. 28, 2024.

(30) Foreign Application Priority Data
Nov. 30, 2023 (CN) 202311631961.8

(51) Int. Cl. G01S 7/481

(52) U.S. Cl. CPC G01S 7/4817; G01S 7/4813; G01S 7/4815; G01S 7/4816

(57) ABSTRACT

An optical scanner system for a LiDAR includes a light emitter, a light receiver, a controller, and a scanner. The light emitter can emit a detection laser. The light receiver can receive an echo generated by reflecting the detection laser by an object and generate an electrical signal based on the echo. The controller can communicate with the light emitter and the light receiver. At least one of the light emitter or the light receiver is arranged on a same circuit board as the controller. The scanner can reciprocate on two sides of an equilibrium position, scan the detection laser towards the outside of the LiDAR, and return the echo back to the inside of the LiDAR.

### CROSS-REFERENCE TO RELATED APPLICATION(S)

This application claims priority to Chinese Patent Application No. 202311631961.8, filed on Nov. 30, 2023, the content of which is incorporated herein by reference in its entirety.

### TECHNICAL FIELD

This disclosure relates to the field of LiDAR and, in particular, to optical scanner systems for a LiDAR and LiDARs.

### BACKGROUND

As a highly integrated sensor, LiDAR is widely used in autonomous driving and other fields to detect objects. With the development of technology and the increasing demand for application, higher requirements are put forward for miniaturization and cost control of LiDAR.

Some existing LiDAR, especially a master LiDAR responsible for detection, can be very expensive. The complex optical, electronic, and mechanical structure designs inside the LiDAR and the requirements for miniaturization and lightweight of the LiDAR can make it difficult to reduce the processing and assembly costs of the LiDAR. It can be beneficial for various optical devices and electronic devices arranged inside the LiDAR to meet the conditions of optical path design and reduce signal interference. It can be difficult to balance low costs and miniaturization.

### SUMMARY

In a first aspect, this disclosure provides an optical scanner system for a LiDAR. The optical scanner system includes a light emitter, a light receiver, a controller, and a scanner. The light emitter is configured to emit a detection laser. The light receiver is configured to receive an echo generated by reflecting the detection laser by an object and generate an electrical signal based on the echo. The controller communicates with both the light emitter and the light receiver. The controller is arranged on a same circuit board as at least one of the light emitter or the light receiver. The scanner is configured to reciprocate on two sides of an equilibrium position, scan the detection laser towards the outside of the LiDAR, and return the echo back to the inside of the LiDAR.

Optionally, the optical scanner system further includes an optical splitter. The optical splitter is arranged in an optical path between the scanner and the light emitter and in an optical path between the scanner and the light receiver. The optical splitter is configured to receive the detection laser, transmit the detection laser to the scanner after transmission, receive the echo from the scanner, and transmit the echo to the light receiver after reflection.

Optionally, the optical scanner system further includes an optical splitter. The optical splitter is arranged in an optical path between the scanner and the light emitter and in an optical path between the scanner and the light receiver. The optical splitter is configured to receive the detection laser, transmit the detection laser to the scanner after reflection, receive the echo from the scanner, and transmit the echo to the light receiver after transmission.

Optionally, the optical scanner system further includes an emitter lens and a receiver lens. The emitter lens is arranged in an optical path between the light emitter and the optical splitter. The emitter lens is configured to receive the detection laser and collimate the detection laser. The receiver lens is arranged in an optical path between the light receiver and the optical splitter. The receiver lens is configured to receive the echo and converge the echo to the light receiver.

Optionally, the optical scanner system further includes at least one reflector. The at least one reflector is arranged in at least one of the optical path between the light emitter and the optical splitter or the optical path between the optical splitter and the light receiver. The at least one reflector is configured to change an optical path direction of at least one of the detection laser or the echo.

Optionally, an optical axis of the emitter lens and an optical axis of the receiver lens are both parallel to the circuit board. The reflector is arranged in at least one of an optical path between the light emitter and the emitter lens or an optical path between the receiver lens and the light receiver.

Optionally, the light emitter and the controller are arranged on the circuit board. An optical axis of the emitter lens is parallel to the circuit board. The reflector is arranged in an optical path between the light emitter and the emitter lens to reflect the detection laser to the emitter lens.

Optionally, the light receiver and the controller are arranged on the circuit board. An optical axis of the receiver lens is parallel to the circuit board. The reflector is arranged in an optical path between the light receiver and the receiver lens to reflect the echo to the light receiver.

Optionally, the light emitter, the light receiver, and the controller are all arranged on the circuit board. The optical scanner system includes two reflectors. The two reflectors are arranged in an optical path between the light emitter and the emitter lens and in an optical path between the light receiver and the receiver lens, respectively, to reflect the detection laser to the emitter lens and reflect the echo to the light receiver.

Optionally, the light emitter, the light receiver, and the controller are all arranged on the circuit board. An optical axis of the receiver lens is perpendicular to the circuit board. An optical axis of the emitter lens is parallel to the circuit board. The detection laser emitted from the light emitter changes in direction by the reflector and then is incident on the emitter lens.

Optionally, the light emitter, the light receiver, and the controller are all arranged on the circuit board. An optical axis of the emitter lens is perpendicular to the circuit board. An optical axis of the receiver lens is parallel to the circuit board. The echo is reflected to the light receiver by the reflector after running through the receiver lens.

Optionally, the optical splitter includes a light reflection portion and a light transmission portion. The light reflection portion is configured to reflect a beam incident on the light reflection portion. The light transmission portion is configured to transmit a beam incident on the light transmission portion.

Optionally, the optical scanner system further includes a shared lens. The shared lens is arranged in an optical path between the optical splitter and the scanner. The shared lens is configured to receive the detection laser, collimate the detection laser, receive the echo, and converge the echo.

Optionally, the optical scanner system further includes a support member fixedly connected to the circuit board. The emitter lens, the receiver lens, the optical splitter, the reflector, and the shared lens are all fixedly mounted on the support member.

Optionally, the support member is integrally formed from a metal material or an organic polymer material. The amount of deformation of the support member within a temperature range of −40 °C to 120 °C is less than a predetermined threshold.

Optionally, the support member includes a hollow portion and a reinforcement portion. The hollow portion is configured to reduce the weight of the support member. The reinforcement portion is configured to enhance the structural strength of the support member.

Optionally, the scanner includes a scanning mirror and a driver. The scanning mirror is connected to the driver. The driver drives the scanning mirror to reciprocate on the two sides of the equilibrium position about a rotating shaft.

Optionally, an angle between the detection laser and the scanning mirror is 30° to 40° when the scanning mirror is located at the equilibrium position.

Optionally, a motion stroke range for the scanning mirror on one side of the equilibrium position is 15° to 30°.

Optionally, the driver includes a stator and a rotor. The scanning mirror is arranged on the rotor, and the rotor drives the scanning mirror to reciprocate on the two sides of the equilibrium position about the rotating shaft.

Optionally, the driver further includes a fixed magnet and a moving magnet. The fixed magnet is fixedly arranged. The moving magnet is arranged on the rotor, moving with the rotor. The fixed magnet and the moving magnet are configured to enable the scanning mirror to return to the equilibrium position by a magnetic force therebetween when the scanning mirror deviates from the equilibrium position.

Optionally, a reciprocating frequency of the scanning mirror is a frequency corresponding to a frequency response peak of the scanner.

Optionally, the light emitter and the controller are both arranged on the circuit board. The light emitter includes a plurality of lasers arranged in an array on the circuit board. The reflector is configured to reflect detection lasers emitted from the plurality of lasers to the scanning mirror. The detection lasers emitted from the plurality of lasers are emitted from the LiDAR through the scanning mirror to form a vertical field of view of the LiDAR.

Optionally, the rotating shaft of the rotor is arranged along a vertical direction. The scanning mirror is driven to scan the detection lasers along a horizontal direction to form a horizontal field of view of the LiDAR.

Optionally, the light emitter is configured to emit the detection laser within a reciprocating stroke range of the scanning mirror.

Optionally, the light emitter includes a plurality of lasers arranged in an array. The light receiver includes a plurality of detectors arranged in an array. The plurality of lasers are in one-to-one correspondence with the plurality of detectors.

Optionally, the light emitter includes a plurality of lasers arranged in an array or a two-dimensional array laser capable of being activated by regions. The light receiver includes a two-dimensional array detector. The two-dimensional array detector is configured to be capable of selecting an activated region for detection. Each laser or an activated region of the two-dimensional array laser corresponds to an activated region of the two-dimensional array detector.

Optionally, the controller is configured to determine information of the object based on the electrical signal.

In a second aspect, this disclosure further provides a LiDAR. The LiDAR includes a housing provided with a window. The optical scanner system as described in the first aspect and optional design. The optical scanner system is arranged in the housing. The detection laser and the echo can be both transmitted from the window.

Optionally, the LiDAR further includes a base. The housing is fixedly connected to the base, to form an accommodating cavity. The optical scanner system is arranged in the accommodating cavity.

Optionally, the window is arranged on one side of the housing close to the scanner.

Optionally, the window is obliquely crossed with a main optical axis of the detection laser.

In some embodiments, in the optical scanner system, at least one of the light emitter or the light receiver is integrated on the same circuit board as the controller. In such a case, the integration level of internal devices of the LiDAR can be improved. The number of circuit boards can be reduced. The costs can be lowered. The batch production can be facilitated. The circuit board in the LiDAR can extend along a direction. The space occupied by the circuit board can be narrowed. The size of the LiDAR can be decreased. For example, the light emitter, the light receiver, and the controller are all arranged on the circuit board in the horizontal direction. The size of the LiDAR in the vertical direction can be decreased. The scanner reciprocates on the two sides of the equilibrium position. The time utilization of the LiDAR within a motion cycle of the scanner can be improved. The time during which detection data is unavailable within the motion cycle of the scanner can be shortened. The capability of the LiDAR to detect distant objects can be enhanced.

In some embodiments, for a LiDAR using the optical scanner system, the integration level of internal devices of the LiDAR can be improved. The number of circuit boards in the LiDAR can be reduced. The costs can be lowered. The batch production can be facilitated. The size of the LiDAR can be decreased. The time utilization of the LiDAR within a motion cycle of the scanner can be improved. The time during which detection data is unavailable within the motion cycle of the scanner can be shortened. The capability of the LiDAR to detect distant objects can be enhanced.

### BRIEF DESCRIPTION OF DRAWINGS

The accompanying drawings are used to provide further understanding of this disclosure and form a part of the specification. They are used together with the embodiments of this disclosure to explain this disclosure and do not limit this disclosure.

FIG. 1 shows a schematic exploded view of an example optical scanner system, consistent with some embodiments of this disclosure.

FIG. 2 shows a top view of the example optical scanner system, consistent with some embodiments of this disclosure.

FIG. 3A and FIG. 3B show schematic diagrams of example optical splitters, consistent with some embodiments of this disclosure.

FIG. 4A to FIG. 4C show schematic diagrams of example optical paths of optical scanner systems, consistent with some embodiments of this disclosure.

FIG. 5A to FIG. 5C show schematic diagrams of example support members, consistent with some embodiments of this disclosure.

FIG. 6 shows a schematic structural diagram of a first example scanner, consistent with some embodiments of this disclosure.

FIG. 7 shows an example frequency response curve of a scanner, consistent with some embodiments of this disclosure.

FIG. 8 shows a corresponding schematic diagram of an example irradiation position of a light emitter on a scanning mirror, consistent with some embodiments of this disclosure.

FIG. 9A to FIG. 9C show corresponding schematic diagrams of example light emitters and light receivers, consistent with some embodiments of this disclosure.

FIG. 10 shows a schematic exploded view of an example LiDAR, consistent with some embodiments of this disclosure.

FIG. 11 shows a schematic structural diagram of the example LiDAR, consistent with some embodiments of this disclosure.

### DESCRIPTION OF EMBODIMENTS

Some example embodiments are briefly described in this disclosure. As recognized by those skilled in the art, the described embodiments can be modified in various different ways without departing from the spirit or scope of this disclosure. In such a case, the accompanying drawings and the description are regarded as example rather than restrictive in nature.

In the description of this disclosure, it is to be understood that the orientations or positional relationships indicated by the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” and the like are based on the orientations or positional relationships shown in the accompanying drawings, merely for conveniently describing this disclosure and simplifying the description, rather than indicating or implying that the apparatus or device referred to must have a particular orientation or be constructed and operated in a particular orientation. In such a case, they cannot be understood as limitations to this disclosure. In addition, the terms “first” and “second” are only for descriptive purposes, and cannot be construed as indicating or implying relative importance or implying the number of technical features indicated. In such a case, the features defined with “first” and “second” can explicitly or implicitly include one or more of the features. In the description of this disclosure, “a plurality of/multiple” means two or more, unless otherwise expressly and specifically defined.

In the description of this disclosure, it is to be noted that the terms “mount,” “connected,” and “connection” should be understood in a broad sense, unless otherwise expressly specified and limited. For example, it can be a fixed connection, a detachable connection, or an integrated connection. It can be a mechanical connection, an electrical connection, or a mutual communication. It can be being directly connected, being indirectly connected via an intermediate medium, a communication between interiors of two devices, or an interaction between two devices. Those of ordinary skill in the art can understand specific meanings of the above terms in this disclosure based on specific circumstances.

In this disclosure, the first feature being “over” or “under” the second feature can include the first and second features being in direct contact with each other, or the first and second features being not in direct contact with each other and being in contact with each other via another feature between them, unless otherwise expressly specified and defined. Moreover, the first feature being “over,” “above,” and “on” the second feature includes the first feature being right above and obliquely above the second feature, or only represents that the horizontal height of the first feature is greater than the horizontal height of the second feature. The first feature being “under,” “below,” and “beneath” the second feature includes the first feature being right below or obliquely below the second feature, or only represents that the horizontal height of the first feature is less than the horizontal height of the second feature.

The disclosure provides many different embodiments or examples for implementing different structures of this disclosure. To simplify the content of this disclosure, components and arrangements in specific examples are described below. Certainly, they are only examples and are not intended to limit this disclosure. In addition, in this disclosure, at least one of reference numerals or reference letters can be repeated in different examples. Such repetition is for the purposes of simplification and clarity, and is not, by itself, indicative of a relationship between at least one of the various embodiments or arrangements discussed. Furthermore, this disclosure provides examples of various specific processes and materials, but those of ordinary skill in the art can be aware of at least one of the application of other processes or the use of other materials.

The embodiments of this disclosure are described below with reference to the accompanying drawings. It should be understood that the embodiments described herein are only for illustrating and explaining this disclosure, rather than limiting this disclosure.

This disclosure provides an optical scanner system for a LiDAR. The optical scanner system includes a light emitter, a light receiver, a controller, and a scanner. The light emitter can emit a detection laser. The light receiver can receive an echo generated by reflecting the detection laser by an object and generate an electrical signal based on the echo. Both the light emitter and the light receiver can communicate with the controller. At least one of the light emitter or the light receiver is arranged on a same circuit board as the controller. The scanner can reciprocate on two sides of an equilibrium position, scan the detection laser towards the outside of the LiDAR, and return the echo back to the inside of the LiDAR.

In some embodiments, at least one of the light emitter or the light receiver can be integrated on the same circuit board as the controller. In such a case, the integration level of internal devices of the LiDAR can be improved. The number of circuit boards can be reduced. The costs can be lowered. It can also be possible to optimize the arrangement position of the circuit board, narrow the space occupied by the circuit board, and decrease the size of the LiDAR. The scanner can reciprocate on the two sides of the equilibrium position. In such a case, the time utilization of the LiDAR within a motion cycle of the scanner can be improved. The time during which detection data is unavailable within the motion cycle of the scanner can be shortened. The capability of the LiDAR to detect distant objects can be enhanced.

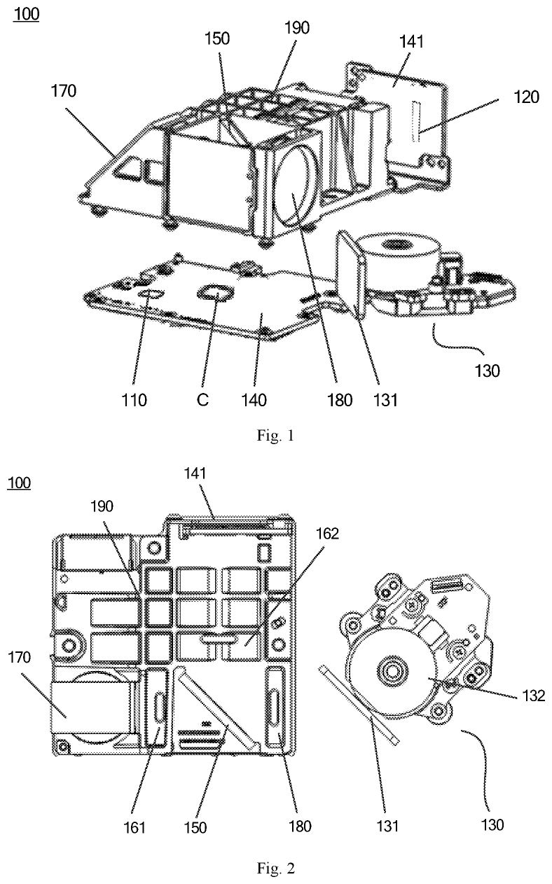

FIG. 1 shows a schematic exploded view of an example optical scanner system, consistent with some embodiments of this disclosure. FIG. 2 shows a top view of the example optical scanner system, consistent with some embodiments of this disclosure. With reference to FIGS. 1 and 2, an optical scanner system 100 includes a light emitter 110, a light receiver 120, a controller C, and a scanner 130. The light emitter 110 can emit a detection laser. For example, the light emitter 110 includes one or more lasers. The laser can emit a laser beam. The laser beam can serve as a detection laser of a LiDAR. The light receiver 120 can receive an echo generated by reflecting the detection laser by an object and generate an electrical signal based on the echo. For example, the light receiver 120 includes one or more photodetectors. After the echo is irradiated on the photodetector, the electrical signal can be generated based on a light signal of the echo.

The light emitter 110 and the light receiver 120 can communicate with the controller C. With reference to FIG. 1, the light emitter 110 and the controller C are arranged on a circuit board 140. The controller C can be a chip integrated on the circuit board 140. For example, the controller can control the light emitter 110 to emit the detection laser and control the light receiver 120 to receive the echo or the like. For another example, the controller C can also receive the electrical signal generated by the light receiver 120 based on the light signal and process the electrical signal to determine three-dimensional spatial position information, surface reflectivity information, and the like of the object reflecting the detection laser.

In some embodiments, still with reference to FIG. 1, the light emitter 110 and the controller C are arranged on the circuit board 140. An optical path direction of the detection laser and an optical path direction of the echo can be changed, to cause the light emitter 110 and the controller C to be located on the same circuit board. In such a case, the number of circuit boards in the LiDAR can be reduced. The space occupied by the circuit board can be narrowed. The size of the LiDAR can be decreased. For example, the height of the LiDAR can be reduced. When the LiDAR is used in the field of autonomous driving, decreasing the size of the LiDAR can also reduce wind resistance of a vehicle during running.

The light receiver 120 can be arranged on another circuit board 141. The another circuit board 141 is different from the circuit board 140. The circuit board 141 provided with the light receiver 120 can have a certain angle with the circuit board 140 provided with the light emitter 110 and the controller C. For example, the angle is approximately 90° in FIG. 1 to match the optical path direction of the echo. The echo can be irradiated on the light receiver 120.

In some embodiments, the light receiver 120 can be arranged on the same circuit board 140 as the controller C. The light emitter 110 is arranged on another circuit board 141. There can be a certain angle between the two circuit boards to match the optical path direction of the detection laser.

In some embodiments, the light emitter 110, the light receiver 120, and the controller C are all arranged on the same circuit board 140. The optical path direction of the detection laser and the optical path direction of the echo can be changed by arranging optical devices. An optical path of the detection laser and an optical path of the echo are described in subsequent embodiments.

In some embodiments, still with reference to FIGS. 1 and 2, the optical scanner system 100 further includes a scanner 130. The scanner 130 can scan the detection laser towards the outside of the LiDAR and return the echo back to the inside of the LiDAR. The scanner 130 can reciprocate on two sides of an equilibrium position. For example, the equilibrium position can be a middle position of a motion stroke of the scanner 130. The motion stroke of the scanner 130 being 60° is used as an example. The scanner 130 has a motion stroke of 30° on each of the two sides of the equilibrium position. For example, the position of the scanner 130 in FIG. 2 is the equilibrium position. In the plane shown in FIG. 2, the scanner 130 can swing in a reciprocating manner on the two sides of the equilibrium position to change the optical path direction of the detection laser and the optical path direction of the echo on the scanner 130. For example, when the detection laser is irradiated on the scanner 130, an emission direction of the detection laser can change with the motion of the scanner 130 to form a scanning field of view of the LiDAR. The echo can be received by the scanner 130, reflected to the inside of the LiDAR, and received by the light receiver 120.

The scanner 130 can reciprocate on the two sides of the equilibrium position. The motion stroke of the scanner 130 on the two sides of the equilibrium position corresponds to the field of view of the LiDAR. The light emitter 110 can emit the detection laser within a reciprocating stroke range of the scanner 130. In such a case, the time utilization of the LiDAR within a motion cycle of the scanner 130 can be improved. The possibility that the detection laser cannot be emitted to determine the echo for a part of time within the motion cycle of the scanner 130 can be reduced. The capability of the LiDAR to detect distant objects can be enhanced.

In some embodiments, the scanner 130 can scan the detection laser and the echo. In such a case, the number of parts or components in the LiDAR can be reduced. The costs of the LiDAR can be lowered. The size of the LiDAR can be decreased.

In some embodiments, both the detection laser and the echo are scanned by the scanner 130. The detection laser and the echo can be shaped by the same optical lens. In such a case, the number of optical devices in the LiDAR can be reduced. The costs of the LiDAR can be lowered. The batch production can be facilitated.

In some embodiments, the optical scanner system 100 further includes an optical splitter 150. The optical splitter 150 can reflect and transmit incident light. The optical splitter 150 is arranged in an optical path between the scanner 130 and the light emitter 110 and in an optical path between the scanner 130 and the light receiver 120. For example, the optical splitter 150 is arranged in the optical path of the detection laser and the optical path of the echo. The optical splitter 150 can split the detection laser and the echo. Correspondingly, the position of the light emitter 110 and the position of the light receiver 120 can be changed. The detection laser can be transmitted towards the scanner 130. The echo can be transmitted towards the light receiver 120. In some embodiments, the optical splitter 150 can be one of a local reflecting optical splitter plate, a local transmitting optical splitter plate, or a polarizing optical splitter plate.

In some embodiments, the optical splitter 150 includes a light reflection portion and a light transmission portion. The light reflection portion and the light transmission portion are arranged in different regions of the optical splitter. The light reflection portion can reflect a beam incident on the light reflection portion. For example, the light reflection portion includes a high-reflectivity film. The light reflection portion can change an optical path direction of the beam. The echo is incident on the light reflection portion. The light reflection portion arranged at an appropriate angle can reflect the echo to the light receiver 120. The light transmission portion can transmit a beam incident on the light transmission portion. For example, the light transmission portion includes a low-reflectivity film. The light transmission portion can not change an optical path direction of the beam. The detection laser is incident on the light transmission portion for transmission.

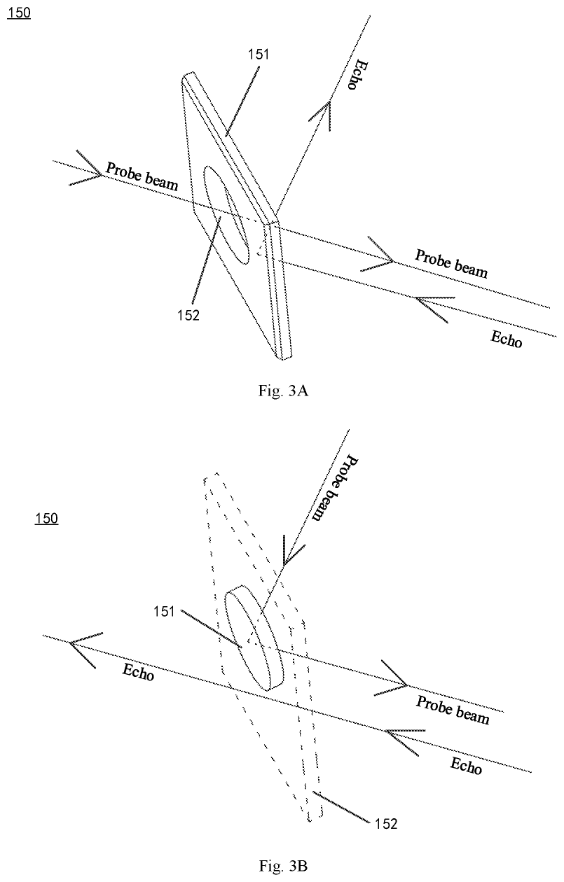

FIG. 3A and FIG. 3B show schematic diagrams of example optical splitters, consistent with some embodiments of this disclosure. In some embodiments, with reference to FIGS. 3A and 3B, the optical splitter 150 can be a platy structure. The light reflection portion and the light transmission portion are located in different regions of the platy structure, respectively.

In some embodiments, with reference to FIG. 3A, a through hole is formed in a center of the optical splitter 150 with the platy structure to form the light transmission portion 152 through which the beam incident on the light transmission portion 152 can directly pass. A part around the through hole forms the light reflection portion 151. A film made from a high-reflectivity material is formed on a surface of the light reflection portion 151. The beam incident on the light reflection portion 151 can be reflected. In some embodiments, the light transmission portion 152 is solid. A film made from a low-reflectivity material can be formed on a surface of the light transmission portion 152 to transmit the beam incident on the light transmission portion 152.

In some embodiments, with reference to FIG. 3B, the center of the optical splitter 150 with the platy structure is solid. For example, a high-reflectivity film is formed on a surface of the optical splitter to form the light reflection portion 151. A peripheral part of the light reflection portion 151 forms the light transmission portion 152. For example, a film made from a low-reflectivity material can be formed on the surface of the light transmission portion 152 to transmit the beam incident on the light transmission portion 152.

In some embodiments, still with reference to FIG. 3A, the light transmission portion 152 in the optical splitter 150 can receive the detection laser. The detection laser can be transmitted to the scanner 130 after being transmitted through the optical splitter 150. The light reflection portion 151 can also receive the echo from the scanner 130. The echo can be transmitted to the light receiver 120 after being reflected at the optical splitter 150. In some embodiments, still with reference to FIG. 3B, the light reflection portion 151 in the optical splitter 150 can receive the detection laser. The detection laser can be transmitted to the scanner 130 after reflection. The light transmission portion 152 can also receive the echo from the scanner 130. The echo can be transmitted to the light receiver 120 after transmission.

The optical splitter 150 can transmit and reflect the detection laser and the echo, respectively. A higher degree of freedom can be provided in optical path design for the detection laser and the echo. In such a case, a conflict in the arrangement positions of the light emitter 110 and the light receiver 120 can be reduced. The detection laser and the echo form a coaxial optical path. A group of optical lenses can be shared for shaping.

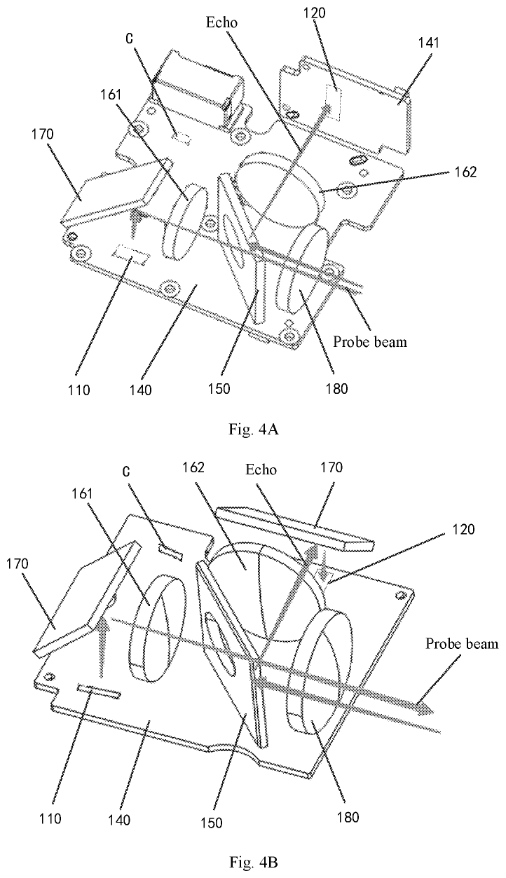

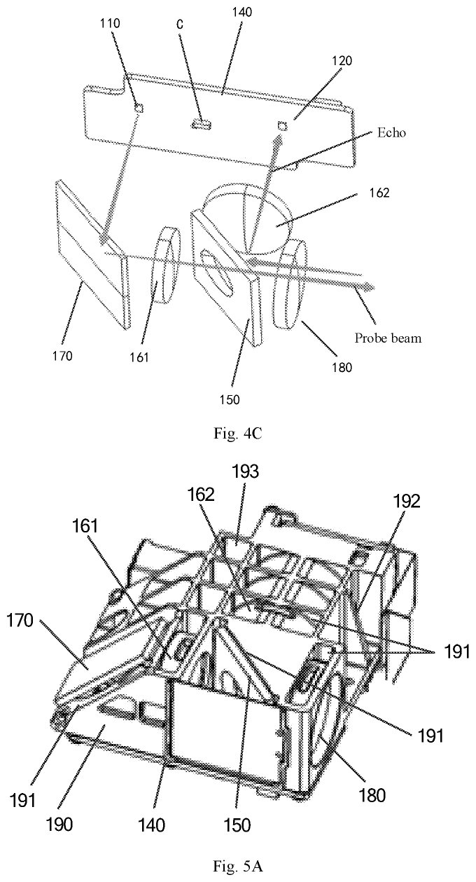

FIG. 4A to FIG. 4C show schematic diagrams of example optical paths of optical scanner systems, consistent with some embodiments of this disclosure. In some embodiments, with reference to FIGS. 4A to 4C, the optical scanner system 100 further includes an emitter lens 161 and a receiver lens 162. The emitter lens 161 is arranged in an optical path between the light emitter 110 and the optical splitter 150. For example, the emitter lens 161 is arranged in the optical path of the detection laser. The emitter lens 161 can receive the detection laser emitted from the light emitter 110 and collimate the detection laser. The detection laser emitted from the light emitter 110 is emitted after collimation. In such a case, a divergence angle of the laser beam can be reduced. The optical power of the detection laser in unit region can be increased. The capability of the LiDAR to detect distant objects can be enhanced. The emitter lens 161 is not limited to a single lens shown in FIG. 4A to FIG. 4C. The emitter lens 161 can also be a lens group including multiple lenses. Based on actual usage requirements of the LiDAR and parameter settings of other parts, for example, based on parameters such as a divergence angle of the detection laser emitted from the light emitter 110 and a distance between the light emitter 110 and the emitter lens 161, the lens or the lens group can be arranged to collimate the detection laser.

The receiver lens 162 is arranged in an optical path between the light receiver 120 and the optical splitter 150. The receiver lens 162 can receive the echo reflected or transmitted by the optical splitter 150 and converge the echo to the light receiver 120. For example, the receiver lens 162 can be a single lens or a lens group including multiple lenses. The receiver lens 162 can converge the echo to make a convergence position of the echo correspond to the light receiver 120. For example, a focal point of the receiver lens 162 can be located on a surface of the light receiver 120. In such a case, the area of the light receiver 120 can be reduced.

In some embodiments, the optical scanner system 100 further includes at least one reflector 170. The reflector 170 can reflect the beam to change the optical path direction of the beam. The reflector 170 is arranged in at least one of an optical path between the light emitter 110 and the optical splitter 150 (as shown in FIG. 1 and FIG. 4A) or an optical path between the optical splitter 150 and the light receiver 120 (as shown in FIG. 4B). For example, the reflector 170 can be arranged in the optical path of the detection laser or the optical path of the echo, or the reflectors 170 are arranged in both the optical path of the detection laser and the optical path of the echo. The reflector 170 can change the optical path direction of at least one of the detection laser or the echo. There can be a higher degree of freedom in the arrangement positions of the light emitter 110 and the light receiver 120. For example, at least one of the light emitter 110 or the light receiver 120 is coplanar with the controller C and is arranged on the same circuit board 140 as the controller C.

The position of the reflector 170 is not limited by the position of the emitter lens 161 and the position of the receiver lens 162. In some embodiments, in the optical path of the detection laser, the reflector 170 can be arranged in an optical path between the light emitter 110 and the emitter lens 161. In some embodiments, in the optical path of the echo, the reflector 170 can be arranged in an optical path between the receiver lens 162 and the light receiver 120. The position of the reflector 170 can be changed based on the structure of the LiDAR to decrease the size of the LiDAR and lower the assembly difficulty of the LiDAR.

In some embodiments, this disclosure provides various optical systems that integrate at least one of the light emitter 110 or the light receiver 120 on the same circuit board 140 as the controller C.

FIG. 4A to FIG. 4C show schematic diagrams of example optical paths of optical scanner systems, consistent with some embodiments of this disclosure. Different optical paths are described below with reference to FIG. 4A to FIG. 4C.

In some embodiments, with reference to FIG. 4A, the light emitter 110 and the controller C are arranged on the circuit board 140. An optical axis of the emitter lens 161 is parallel to the circuit board 140. The reflector 170 is arranged in the optical path between the light emitter 110 and the emitter lens 161. The reflector 170 can reflect the detection laser to the emitter lens 161. The receiver lens 162 is arranged in the optical path between the light receiver 120 and the optical splitter 150. An optical axis of the receiver lens 162 is perpendicular to the circuit board 141. An angle between the circuit board 141 and the circuit board 140 can be changed based on the structure of the LiDAR.

In some embodiments, the optical axis of the emitter lens 161 and the optical axis of the receiver lens 162 are both parallel to the circuit board 140 (e.g., shown in FIG. 4A). The reflector 170 is arranged in the optical path between the light emitter 110 and the emitter lens 161. The arrows in FIG. 4A represent the optical path direction of the detection laser and the optical path direction of the echo.

The light emitter 110 and the controller C are integrated on the circuit board 140. The light receiver 120 is arranged on the circuit board 141. The detection laser emitted from the light emitter 110 is transmitted to the emitter lens 161 after being reflected by the reflector 170. For example, a main optical axis of the detection laser emitted from the light emitter 110 is perpendicular to the circuit board 140. An incident angle of the detection laser on the reflector 170 is 45°. After being reflected by the reflector 170, the detection laser is transmitted along an optical axis direction of the emitter lens 161 and collimated by the emitter lens 161. After being reflected by the optical splitter 150, the echo is converged by the receiver lens 162 and is incident on the light receiver 120. The circuit board 141 where the light receiver 120 is located can be set to be approximately perpendicular to the circuit board 140.

In some embodiments, the light receiver 120 and the controller C in the optical scanner system 100 are arranged on the circuit board 140. The optical axis of the receiver lens 162 is parallel to the circuit board 140. The reflector 170 is arranged in the optical path between the light receiver 120 and the receiver lens 162. The reflector 170 can change the optical path direction of the echo and reflect the echo to the light receiver 120. The emitter lens 161 is arranged in the optical path between the light emitter 110 and the optical splitter 150. The optical axis of the emitter lens 161 is perpendicular to the circuit board 141.

The reflector 170 can also be arranged in the optical path between the receiver lens 162 and the light receiver 120. The detection laser emitted from the light emitter 110 is parallel to the optical axis of the emitter lens 161. The light receiver 120 and the controller C are arranged on the circuit board 140. The position of the light emitter 110 and the position of the light receiver 120 as shown in FIG. 4A are interchanged. The position of the emitter lens 161 and the position of the receiver lens 162 are interchanged.

In some embodiments, with reference to FIG. 4B, the optical scanner system 100 includes two reflectors 170. The light emitter 110, the light receiver 120, and the controller C are all arranged on the circuit board 140. The optical axis of the emitter lens 161 and the optical axis of the receiver lens 162 are both parallel to the circuit board 140. The two reflectors 170 are arranged in the optical path between the light emitter 110 and the emitter lens 161 and in the optical path between the light receiver 120 and the receiver lens 162, respectively. The two reflectors 170 can change the optical path direction of the detection laser and the optical path direction of the echo.

The detection laser emitted from the light emitter 110 is incident on the emitter lens 161 after being reflected by the reflector 170. The detection laser emitted from the light emitter 110 is incident on the optical splitter 150 after collimation. After being converged by the receiver lens 162, the echo reflected by the optical splitter 150 is reflected by the other reflector 170 and received by the light receiver 120. The two reflectors 170 are both set to have an angle of 45°with the circuit board 140. The main optical axis of the detection laser reflected by the reflector 170 is parallel to the optical axis of the emitter lens 161. The main optical axis of the echo reflected by the reflector 170 is vertically incident on the surface of the light receiver 120.

In some embodiments, with reference to FIG. 4C, the light emitter 110, the light receiver 120, and the controller C are all arranged on the circuit board 140. The optical axis of the receiver lens 162 is perpendicular to the circuit board 140. The optical axis of the emitter lens 161 is parallel to the circuit board 140. The reflector 170 is arranged in the optical path between the light emitter 110 and the emitter lens 161. The detection laser emitted from the light emitter 110 is incident on the emitter lens 161 for collimation after being reflected by the reflector 170. After being reflected by the optical splitter 150, the echo is converged by the receiver lens 162 and is incident on the light receiver 120.

In some embodiments, the optical axis of the emitter lens 161 can also be set to be perpendicular to the circuit board 140. The optical axis of the receiver lens 162 is parallel to the circuit board 140. After being converged by the receiver lens 162, the echo is reflected to the light receiver 120 by the reflector 170. For example, the position of the light emitter 110 and the position of the light receiver 120 shown in FIG. 4C can be interchanged. The position of the emitter lens 161 and the position of the receiver lens 162 can also be interchanged correspondingly. In some embodiments, the optical axis of the emitter lens 161 and the optical axis of the receiver lens 162 can also be set to be both perpendicular to the circuit board 140, and correspond to the light emitter 110 and the light receiver 120, respectively. The reflector 170 is arranged in at least one of an optical path between the emitter lens 161 and the optical splitter 150 or an optical path between the receiver lens 162 and the optical splitter 150.

In some embodiments, the optical axis of the emitter lens 161 and the optical axis of the receiver lens 162 are both perpendicular to the circuit board 140. The reflector 170 is arranged in at least one of the optical path between the emitter lens 161 and the optical splitter 150 or the optical path between the receiver lens 162 and the optical splitter 150. An angle between the reflector 170 and the circuit board 140 is set to 45°. The detection laser is reflected to the optical splitter 150 by the reflector 170 after being collimated by the emitter lens 161. The echo is converged to the light receiver 120 by the receiver lens 162 after being reflected by the reflector 170.

In some embodiments, with reference to FIGS. 1 and 2, the optical scanner system 100 further includes a shared lens 180. The shared lens 180 is arranged in an optical path between the optical splitter 150 and the scanner 130. The detection laser and the echo both can pass through the shared lens 180. The shared lens 180 can receive the detection laser passing through the optical splitter 150 and collimate the detection laser. The shared lens 180 can also receive the echo reflected by the scanner 130, converge the echo, and emit the echo to the optical splitter 150. The shared lens 180 can be a single lens or a lens group including multiple lenses.

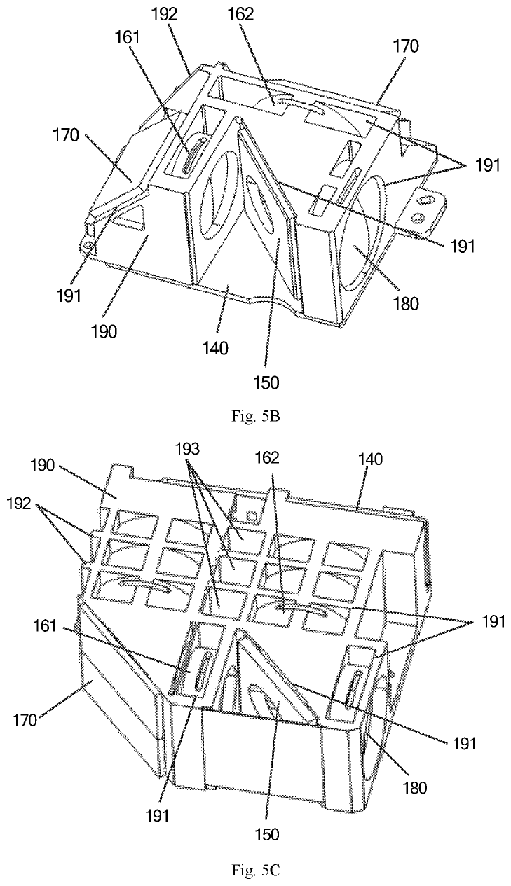

In some embodiments, with reference to FIGS. 5A to 5C, the optical scanner system 100 further includes a support member 190. The support member 190 is fixedly connected to the circuit board 140. For example, the circuit board 140 is provided with a through hole. The support member 190 is provided with a corresponding through hole or countersunk hole. The circuit board 140 and the support member 190 are fixedly connected by bolts. In some embodiments, the support member 190 and the circuit board 140 can also be connected by means of buckles, adhesion, or the like. The support member 190 can be arranged to fix and protect the optical devices and the circuit board 140 to improve the structural stability of the LiDAR.

In some embodiments, the support member 190 can fixedly mount the emitter lens 161, the receiver lens 162, the optical splitter 150, the reflector 170, and the shared lens 180. The above optical device is maintained at a predetermined position in the support member 190. The optical path can remain stable.

A mounting portion 191 can be provided in the support member 190. The mounting portion 191 can fixedly mount the optical devices such as the emitter lens 161, the receiver lens 162, the optical splitter 150, the reflector 170, and the shared lens 180 based on a predetermined optical path. The mounting portion 191 can be processed to be of different structures such as a slot and an inclined surface.

FIG. 5A to FIG. 5C show schematic diagrams of example support members, consistent with some embodiments of this disclosure. The structures of the support members 190 in FIG. 5A to FIG. 5C correspond to the optical paths shown in FIG. 4A to FIG. 4C. The emitter lens 161, the receiver lens 162, and the shared lens 180 can be embedded in the mounting portion 191 with a slot shape in the support member 190. The optical splitter 150 and the reflector 170 can be mounted on the mounting portion 191 with an inclined surface shape of a predetermined angle in the support member 190. An optical distance between the optical devices, such as an optical distance between the emitter lens 161 and the light emitter 110, an optical distance between the shared lens 180 and the emitter lens 161, or an optical distance between the shared lens and the receiver lens 162, is also be controlled by the support member 190.

In some embodiments, the support member 190 is integrally formed from a metal material or an organic polymer material. For example, the support member 190 is made from the organic polymer material. The weight of the LiDAR can be reduced. The support member 190 can fix various optical devices in the optical scanner system 100. The possibility of the optical devices moving with deformation of the support member 190 to affect normal operation of the LiDAR can be decreased. In some embodiments, the amount of deformation of the support member 190 within a temperature range of −40 °C to 120 °C is set to less than a predetermined threshold. The predetermined threshold is determined based on a specific application scene of the LiDAR. For example, the predetermined threshold is 0.1 mm.

In some embodiments, the support member 190 further includes a reinforcement portion 192. The reinforcement portion 192 can be a reinforcing rib, a rib plate, or any other structure. For example, the reinforcement portion is arranged at a circumferential position of the support member 190. The structural strength of the support member 190 can be improved. The reinforcement portion can also be used as a positioning element or a fixing element. The reinforcement portion is connected to another structure in the LiDAR.

In some embodiments, with reference to FIG. 5C, the support member 190 further includes a hollow portion 193. The hollow portion 193 can reduce the weight of the support member 190. At a position in the support member 190 that does not block the optical path of the detection laser and the optical path of the echo, some structures in the support member 190 can be removed. The overall weight of the LiDAR can be reduced on the premise of ensuring the structural strength.

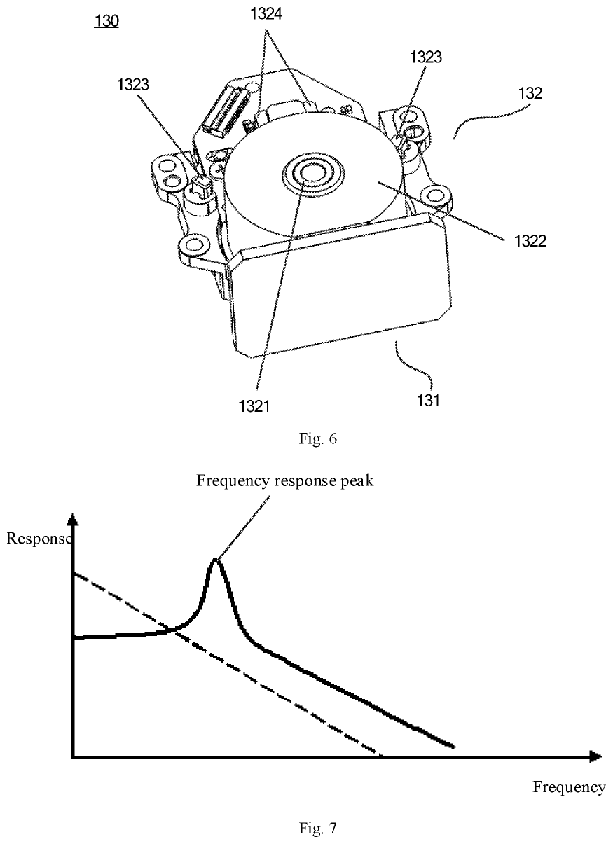

FIG. 6 shows a schematic structural diagram of a first example scanner, consistent with some embodiments of this disclosure. In some embodiments, a first example scanner (e.g., the scanner 130 shown in FIG. 6) is described below.

In some embodiments, the scanner 130 includes a scanning mirror 131 and a driver 132. The scanning mirror 131 is arranged on the driver 132. The driver 132 can drive the scanning mirror 131 to reciprocate on the two sides of the equilibrium position about a rotating shaft.

The scanning mirror 131 can be a reflector. The scanning mirror 131 can reflect a beam irradiated thereon. The detection laser is emitted to the outside of the LiDAR after being reflected by the scanning mirror 131. The echo can also be reflected by the scanning mirror 131 to the inside of the optical scanner system 100. For example, after being reflected by the scanning mirror 131, the echo can pass through the shared lens 180, the optical splitter 150, and the receiver lens 162 in sequence and then is received by the light receiver 120.

In some embodiments, the scanning mirror 131 can be driven by the driver 132 to reciprocate on the two sides of the equilibrium position. Compared with a unidirectional rotating scanner with four or more reflectors, the scanner 130 in these embodiments are only provided with a reflector. In such a case, the costs can be greatly lowered. The driver 132 can be arranged side by side with the scanning mirror 131 and can extend transversely in the plane shown in FIG. 2. The scanner 130 has a smaller overall structural size, such as having a lower height in the direction of the rotating shaft, and the size of the LiDAR can be decreased.

In some embodiments, the scanner 130 has higher time utilization. In the unidirectional rotating scanner with the multiple reflectors, when one reflector rotates till a position where the detection laser is irradiated is located in an edge region of the reflector, an emission direction of reflected light of the detection laser on the surface of the reflector has exceeded the field of view of the LiDAR. The detection laser reflected in the edge region of the reflector cannot detect the object. A unidirectional rotating scanner with four reflectors is used as an example. An angle (e.g., 60°) of a central region on each reflector corresponds to the field of view (e.g., 120°) of the LiDAR. An angle (e.g., 15° on each of two sides) of edge regions on two sides of the reflector exceeds the field of view of the LiDAR. The detection laser reflected in the edge region cannot detect the object. There can be a certain angle (e.g., 120°), at which the object cannot be detected, within one motion cycle (e.g., 360° rotation) of the unidirectional rotating scanner. In some embodiments, the reciprocating stroke of the scanner 130 on the two sides of the equilibrium position is set to correspond to the field of view of the LiDAR. For example, a reciprocating stroke of the scanning mirror 131 driven by the driver 132 is 60°. A corresponding horizontal field of view of the LiDAR is 120°. Throughout the entire motion cycle of the scanner, the reflected detection laser can detect the object in the field of view of the LiDAR. The light emitter 110 can be set to emit the detection laser in the reciprocating stroke range of the scanning mirror 131 to detect the object in the field of view of the LiDAR.

In some embodiments, the reciprocating stroke range of the scanning mirror 131 on one side of the equilibrium position is set to 15° to 30°. For example, the reciprocating stroke of the scanning mirror 131 on the one side of the equilibrium position is 30°. The motion stroke ranges of the scanning mirror 131 on the two sides of the equilibrium position are symmetrical with respect to the equilibrium position. The reciprocating stroke of the scanning mirror 131 is 60°. The horizontal field of view of the LiDAR formed by scanning the detection laser by the scanning mirror 131 that reciprocates is 120°.

In some embodiments, when the scanning mirror 131 is located at the equilibrium position, an angle between the detection laser and the scanning mirror 131 is 30° to 40°, for example, 35°. With reference to FIG. 6, the driver 132 is arranged on one side of the scanning mirror 131 to reduce the height of the scanner 130 in the direction of the rotating shaft. The angle between the scanning mirror 131 and the detection laser at the equilibrium position can be changed to reduce the transverse size (the transverse direction shown in FIG. 2) of the optical scanner system 100 and decrease the size of the LiDAR.

In some embodiments, with reference to FIG. 6, the driver 132 includes a stator 1321 and a rotor 1322. The scanning mirror 131 is arranged on the rotor 1322. The scanning mirror 131 is driven by the rotor 1322 to reciprocate on the two sides of the equilibrium position about the rotating shaft. The stator 1321 is provided with a coil. The rotor 1322 further includes a permanent magnet. After the coil is energized, a magnetic field can be generated. The magnitude and direction of a current in the coil can be changed to generate a changing magnetic field. The permanent magnet in the rotor 1322 is driven in the changing magnetic field to move. The rotor is driven to move relative to the stator from the equilibrium position. The direction of the current in the coil can be changed to change the direction of the magnetic field. The direction of a torque driving the rotor 1322 to rotate can be changed to implement a decelerated or reverse motion of the rotor 1322.

In some embodiments, the driver 132 further includes a fixed magnet 1323 and a moving magnet 1324. The fixed magnet 1323 is at a fixed position. The moving magnet 1324 is arranged on the rotor 1322. The moving magnet 1324 can move with the rotor 1322. The fixed magnet 1323 and the moving magnet 1324 are arranged in a manner that the scanning mirror 131 returns to the equilibrium position by a magnetic force between the fixed magnet 1323 and the moving magnet 1324 when the scanning mirror 131 deviates from the equilibrium position.

With reference to FIG. 6, when the rotor 1322 drives the scanning mirror 131 to move from the equilibrium position, the position of the fixed magnet 1323 remains fixed, and the moving magnet 1324 can move with the rotor 1322. When the fixed magnet 1323 and the moving magnet 1324 approach each other, kinematic potential energy of the rotor 1322 is absorbed by a magnetic field between the fixed magnet 1323 and the moving magnet 1324, potential energy of the magnetic field is generated based on the kinematic potential energy, and a mechanical model similar to a spring is formed. The driver can be regarded as a spring device (e.g., a magnetic spring) within a certain range. When the rotor 1322 moves to a farthest end from the equilibrium position, potential energy of the magnetic spring reaches the maximum. The potential energy of the magnetic field can be released to enable the rotor 1322 to make a turn and return to the equilibrium position. The magnetic force between the fixed magnet 1323 and the moving magnet 1324, the distance therebetween, or the like can be changed to change a motion stroke range of the rotor 1322.

The driver 132 includes a set of motion system. The motion system includes the stator 1321, the rotor 1322, interaction between the fixed magnet 1323 and the moving magnet 1324. A mechanical model for the driver 132 can be simplified as a second-order resonant system. A gain (e.g., a rotation angle of the rotor 1322 relative to the stator 1321) of a magnetic spring structure has a peak value. FIG. 7 shows an example frequency response curve of a scanner, consistent with some embodiments of this disclosure. With reference to FIG. 7, a dashed line represents a frequency response curve of a conventional motor. The solid line represents a frequency response curve of the driver 132 with the magnetic spring structure in these embodiments. In the conventional motor, the gain response linearly decreases as the frequency increases. In some embodiments, the driver 132 has a resonant frequency point. A frequency point corresponding to a maximum gain is the resonant frequency point. At the resonant frequency point, the corresponding gain has a peak value. For example, the rotation angle of the rotor 1322 relative to the stator 1321 is maximum. In some embodiments, the rotor 1322 has a large motion stroke range at low driving power. The scanning mirror 131 can move at a large angle without greatly increasing the power of the driver.

The resonant frequency can be changed based on structural parameters of the driver 132. The resonant frequency point is set as an operating frequency (e.g., 10 Hz). A required stiffness coefficient K=J(2πf₀)² can be calculated based on the operating frequency f₀ and rotational inertia J of a load. The rotational inertia J depends on the scanning mirror 131. The stiffness coefficient K represents the stiffness of the spring (e.g., the magnetic spring in these embodiments) in the second-order resonant system. An actual stiffness coefficient k of the magnetic spring is designed as the required stiffness coefficient K.

In some embodiments, the actual stiffness coefficient K of the magnetic spring can be calculated based on the following formula:

K=n*k.

In the formula, n represents the number of pairs of magnetic springs, and k represents the stiffness coefficient of a single magnetic spring. For example, in the scanner 130 shown in FIG. 6, one fixed magnet 1323 and one moving magnet 1324 form one magnetic spring. In each magnetic spring, a gap between the fixed magnet 1323 and the moving magnet 1324, and geometric parameters of the fixed magnet 1323 and the moving magnet 1324 can determine the stiffness coefficient k of the magnetic spring. For example, the smaller the gap is, the larger the stiffness coefficient k of the single magnetic spring is.

In some embodiments, the fixed magnet 1323 can include multiple magnets. The moving magnet 1324 can include multiple magnets. The fixed magnet 1323 and the moving magnet 1324 are matched in pairs. With reference to FIG. 6, two fixed magnets 1323 and two moving magnets 1324 are arranged. The fixed magnets 1323 and the moving magnets 1324 are in one-to-one correspondence and form two magnetic springs.

In some embodiments, with reference to FIG. 4A and FIG. 4B, the light emitter 110 and the controller C are both arranged on the circuit board 140. The light emitter 110 includes multiple lasers 111 arranged in an array on the circuit board 140. For example, the array can be a one-dimensional array or a two-dimensional array. In some embodiments, with reference to FIG. 2, the circuit board 140 is perpendicular to a rotating shaft of the scanning mirror 131. The multiple lasers 111 are arranged on the circuit board 140 along an extension direction (e.g., a horizontal direction) of the circuit board 140. An arrangement direction (e.g., a horizontal direction) of the lasers 111 is the same as a scanning direction (e.g., a horizontal direction) of the scanning mirror 131. In some embodiments, the reflector 170 can reflect detection lasers emitted from the multiple lasers 111 to the scanning mirror 131. The detection lasers are emitted from the LiDAR after being reflected by the scanning mirror 131 to form a vertical field of view of the LiDAR.

The rotating shaft of the rotor 1322 is arranged along a vertical direction. The scanning mirror 131 is driven to scan the detection lasers along a horizontal direction to form a horizontal field of view of the LiDAR. For example, as the scanning mirror 131 rotates, the emission direction of the detection laser can also rotate in the horizontal direction after the detection laser is reflected by the scanning mirror 131, to form the horizontal field of view of the LiDAR.

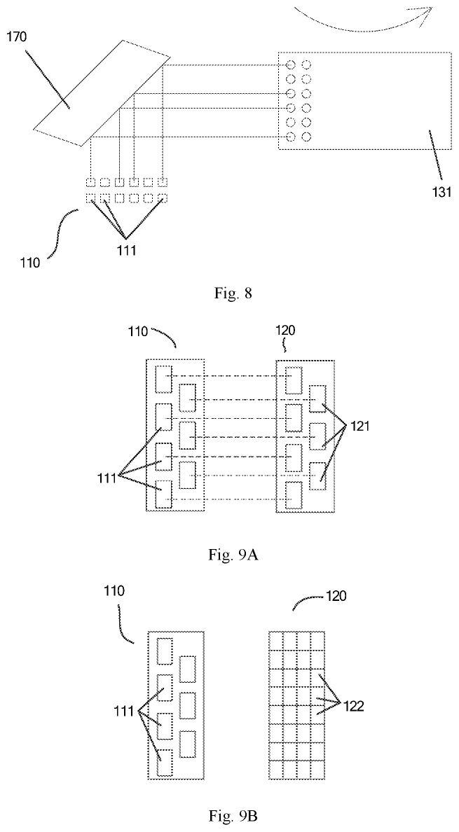

The circuit board 140 is horizontally arranged. The lasers 111 are arranged and extend in the horizontal direction. FIG. 8 shows a corresponding schematic diagram of an example irradiation position of a light emitter on a scanning mirror, consistent with some embodiments of this disclosure. With reference to FIG. 8, after the detection lasers emitted from the lasers 111 arranged in the horizontal direction are reflected by the reflector 170, the optical path direction of the detection lasers can be changed to form a detection laser array arranged along the vertical direction. The detection lasers are irradiated on the scanning mirror 131 and reflected by the scanning mirror 131 to form the vertical field of view of the LiDAR.

With reference to FIG. 8, when the scanning mirror 131 is at a certain angle, the detection laser emitted from the laser 111 is emitted from the LiDAR after being scanned by the scanning mirror 131. At this scanning angle, a set of emission fields of view of all the lasers 111 in the light emitter 110 can cover the vertical field of view of the LiDAR. As the scanning mirror 131 reciprocates on the two sides of the equilibrium position, the emission field of view formed by the detection laser emitted from the laser 111 can perform scanning along the horizontal direction with the scanning mirror 131 to form the horizontal field of view of the LiDAR.

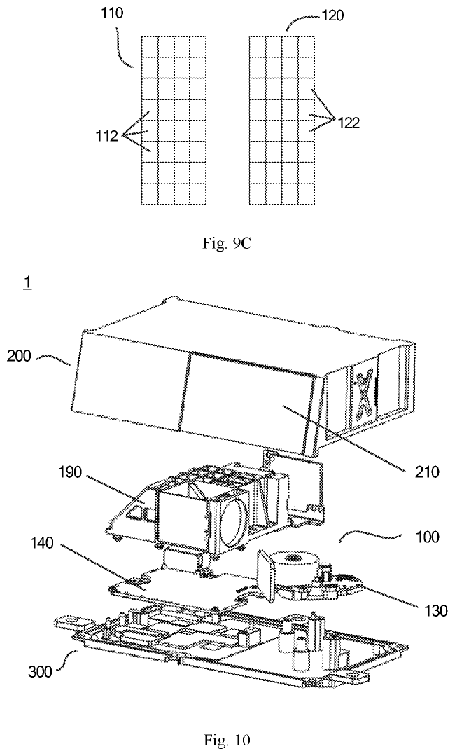

FIG. 9A to FIG. 9C show corresponding schematic diagrams of example light emitters and light receivers, consistent with some embodiments of this disclosure. In some embodiments, the scanner 130 can perform one-dimensional scanning along the horizontal direction. The light emitter 110 includes multiple lasers 111 arranged in an array to form the vertical field of view of the LiDAR. With reference to FIG. 9A, the multiple lasers 111 are arranged in a two-dimensional array or in two columns. The lasers 111 in adjacent columns are staggered along a column direction. In some embodiments, the arrangement of the multiple lasers 111 is not limited to the two columns. For example, the lasers can be arranged in three or more columns, or the lasers can be arranged in a one-dimensional array or in one column. The light receiver 120 includes multiple detectors 121 arranged in an array, such as the two-dimensional array shown in FIG. 9A. The multiple detectors 121 are arranged in two columns. The lasers 111 in adjacent columns are staggered along a column direction. The lasers can also be arranged in more columns, or the lasers can be arranged in a one-dimensional array or in one column. The multiple lasers 111 in the light emitter 110 are in one-to-one correspondence with the multiple detectors 121 in the light receiver 120. The laser 111 can be a vertical cavity surface emitting laser (“VCSEL”). The detector 121 can be one of a single silicon photomultiplier (“SiPM”), a SiPM array, or a single photon avalanche diode (“SPAD”) array. For example, each SiPM array includes multiple SiPMs arranged along a column direction. Each SPAD array includes a two-dimensional array SPAD. Multiple SPADs are uniformly arranged along a row direction and a column direction to form the two-dimensional array SPAD. Each SiPM, SiPM array, or SPAD array can correspond to one VCSEL. It can be determined whether one VCSEL corresponds to one SiPM or one SiPM array based on the size of the VCSEL.

In some embodiments, with reference to FIG. 9B, the light emitter 110 includes multiple lasers 111 arranged in an array. The multiple lasers 111 are arranged in a two-dimensional array or in two columns. The lasers 111 in adjacent columns are staggered along a column direction. In some embodiments, the arrangement of the multiple lasers 111 is not limited to the two columns. For example, the lasers can be arranged in three or more columns, or the lasers can be arranged in a one-dimensional array or in one column. The light receiver 120 includes a two-dimensional array detector. The two-dimensional array detector can activate any region. One laser 111 in the light emitter 110 corresponds to one activated region 122 in the two-dimensional array detector. For example, the laser 111 can be a VCSEL. The light receiver 120 can include a two-dimensional array SPAD. Multiple SPADs are uniformly arranged along a row direction and a column direction to form the two-dimensional array SPAD. The two-dimensional array SPAD includes multiple pixels (e.g., activated regions 122). Each pixel includes multiple SPADs such as 2*2 or 3*3 SPADs. Each pixel can be separately activated to form the activated region 122. The light receiver 120 in FIG. 9B is only an example. In some embodiments, the activated regions 122 in the two-dimensional array SPAD can be arbitrarily divided. Each activated region 122 can include one or more pixels. One VCSEL corresponds to one activated region 122 in the two-dimensional array SPAD. One VCSEL can correspond to one or more pixels in the two-dimensional array SPAD.

In some embodiments, with reference to FIG. 9C, the light emitter 110 includes a two-dimensional array laser capable of being activated by regions. The light receiver 120 includes a two-dimensional array detector. The two-dimensional array laser can be activated by regions. For example, the two-dimensional array laser can be a large-sized two-dimensional array VCSEL (e.g., a 3 mm*5 mm surface light source). The two-dimensional array VCSEL has multiple light-emitting points arranged in a two-dimensional array. The large-sized VCSEL can emit light by gating of regions (e.g., emit light by separate gating of rows/columns in the two-dimensional array VCSEL). Different activated regions 112 are formed to emit detection lasers. The light receiver 120 can include a two-dimensional array SPAD. Multiple SPADs are uniformly arranged along a row direction and a column direction to form the two-dimensional array SPAD. The two-dimensional array SPAD includes multiple pixels (e.g., activated regions 122). Each pixel includes multiple SPADs such as 2*2 or 3*3 SPADs. Each pixel can be separately activated to form an activated region 122. Each activated region 122 can include one or more pixels. One activated region 112 in the two-dimensional array VCSEL corresponds to one activated region 122 in the two-dimensional array SPAD.

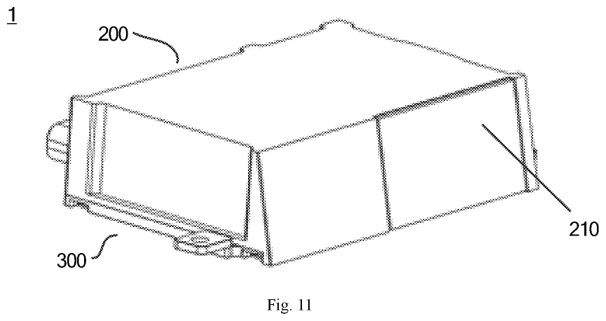

FIG. 10 shows a schematic exploded view of an example LiDAR, consistent with some embodiments of this disclosure. FIG. 11 shows a schematic structural diagram of the example LiDAR, consistent with some embodiments of this disclosure. In some embodiments, this disclosure provides a LiDAR. With reference to FIGS. 10 and 11, the LiDAR 1 includes the optical scanner system 100 as described.

The LiDAR 1 includes a housing 200 and the optical scanner system 100. A light-transmitting window 210 is arranged on the housing 200. The optical scanner system 100 is arranged inside the housing 200. Both the detection laser and the echo can be transmitted through the window 210. The housing 200 can protect the optical scanner system 100. The shape of the housing 200 can also be set based on an application scene of the LiDAR. For example, the housing in the LiDAR can fit with the appearance of a vehicle.

The LiDAR 1 further includes a base 300. The base 300 is fixedly connected to the housing 200 to form an accommodating cavity. The optical scanner system 100 is arranged inside the accommodating cavity. The base 300 can match with a mounting structure (e.g., a mounting structure on the vehicle) of the LiDAR 1 and fix the LiDAR 1 to a predetermined position. Based on an application scene and a mounting position of the LiDAR 1, the housing 200 can also match with the mounting position of the LiDAR 1.

With reference to FIG. 2, the scanner 130 is arranged on one side of the optical scanner system 100. The position of the window 210 on the housing 200 corresponds to the position of the scanner 130. For example, the height of the window 210 is greater than the height of the scanner 130, and the length of the window 210 matches with a scanning range of the scanner 130. In such a case, the possibility of regions outside the window 210 in the housing 200 blocking the detection laser can be decreased.

In some embodiments, with reference to FIG. 11, the window 210 is inclined relative to the vertical direction and is set to be obliquely crossed with the main optical axis of the detection laser. The main optical axis of the detection laser represents the main optical axis of the detection laser reflected from the scanning mirror 131 (as shown in FIG. 8). The window 210 is obliquely crossed with the main optical axis of the detection laser. In such a case, the possibility of the detection laser being vertically irradiated on the window 210 can be reduced, to cause the detection laser reflected to the inside of the LiDAR from the surface of the window 210 and the interference to the LiDAR 1 to be reduce.

Finally, it should be noted that the descriptions are only the embodiments of this disclosure and are not intended to limit this disclosure. While this disclosure has been described in detail with reference to the embodiments, those skilled in the art can still modify the technical solutions described in the aforementioned embodiments or equivalently replace some of the technical features. Any modifications, equivalent replacements, improvements, or the like made within the spirit and principle of this disclosure shall be included within the scope of protection of this disclosure.

1. An optical scanner system for a LiDAR, comprising:
a light emitter configured to emit a detection laser;
a light receiver configured to receive an echo generated upon reflection of the detection laser from an object and generate an electrical signal based on the echo;
a controller, in communication with both the light emitter and the light receiver, arranged on a same circuit board as at least one of the light emitter or the light receiver; and
a scanner configured to reciprocate on two sides of an equilibrium position, scan the detection laser towards an outside of the LiDAR, and return the echo back to an inside of the LiDAR.

2. The optical scanner system of claim 1, further comprising:
an optical splitter arranged in an optical path between the scanner and the light emitter and in an optical path between the scanner and the light receiver, and configured to receive the detection laser, transmit the detection laser to the scanner, receive the echo from the scanner, and transmit the echo to the light receiver.

3. (canceled)

4. The optical scanner system of claim 2, further comprising:
an emitter lens arranged in an optical path between the light emitter and the optical splitter, and configured to receive the detection laser ; and
a receiver lens arranged in an optical path between the light receiver and the optical splitter, and configured to receive the echo.

5. The optical scanner system of claim 4, further comprising:
at least one reflector arranged in at least one of the optical path between the light emitter and the optical splitter or the optical path between the optical splitter and the light receiver, and configured to change an optical path direction of at least one of the detection laser or the echo.

6. The optical scanner system of claim 5, wherein an optical axis of the emitter lens and an optical axis of the receiver lens are both parallel to the circuit board; and the reflector is arranged in at least one of an optical path between the light emitter and the emitter lens or an optical path between the receiver lens and the light receiver.

7. (canceled)

8. The optical scanner system of claim 5, wherein the light emitter, the light receiver, and the controller are arranged on the circuit board, and the optical scanner system comprises a first reflector and a second reflector, wherein the first reflector is arranged in an optical path between the light emitter and the emitter lens to reflect the detection laser to the emitter lens, and the second reflector is arranged in an optical path between the light receiver and the receiver lens to reflect the echo to the light receiver.

9. (canceled)

10. (canceled)

11. The optical scanner system of claim 5, further comprising:
a shared lens arranged in an optical path between the optical splitter and the scanner, and configured to receive the detection laser and the echo.

12. The optical scanner system of claim 11, further comprising:
a support member fixedly connected to the circuit board, wherein the emitter lens, the receiver lens, the optical splitter, the reflector, and the shared lens are fixedly mounted on the support member.

13. The optical scanner system of claim 12, wherein the support member is integrally formed from a metal material or an organic polymer material, and an amount of deformation of the support member within a temperature range of −40 °C to 120 °C is smaller than a predetermined threshold.

14. The optical scanner system of claim 12, wherein the support member comprises a hollow portion and a reinforcement portion, wherein the hollow portion is configured to reduce a weight of the support member; and the reinforcement portion is configured to enhance a structural strength of the support member.

15. The optical scanner system of claim 5, wherein the scanner comprises a scanning mirror and a driver, wherein the scanning mirror is connected to the driver, and the driver drives the scanning mirror to reciprocate on the two sides of the equilibrium position about a rotating shaft.

16. The optical scanner system of claim 15, wherein an angle between the detection laser and the scanning mirror is 30° to 40° when the scanning mirror is located at the equilibrium position.

17. (canceled)

18. The optical scanner system of claim 15, wherein the driver comprises a stator and a rotor, wherein the scanning mirror is arranged on the rotor, and the rotor drives the scanning mirror to reciprocate on the two sides of the equilibrium position about the rotating shaft.

19. (canceled)

20. (canceled)

21. The optical scanner system of claim 18, wherein the light emitter and the controller are both arranged on the circuit board, and the light emitter comprises a plurality of lasers arranged in an array on the circuit board, wherein the reflector is configured to reflect detection lasers emitted from the plurality of lasers to the scanning mirror, and the detection lasers emitted from the plurality of lasers are emitted from the LiDAR through the scanning mirror to form a vertical field of view of the LiDAR.

22. The optical scanner system of claim 21, wherein the rotating shaft of the rotor is arranged along a vertical direction, and the scanning mirror is driven to scan the detection lasers along a horizontal direction to form a horizontal field of view of the LiDAR.

23. (canceled)

24. The optical scanner system of claim 1, wherein the light emitter comprises a plurality of lasers arranged in an array, and the light receiver comprises a plurality of detectors arranged in an array, wherein the plurality of lasers are in one-to-one correspondence with the plurality of detectors; or
the light emitter comprises a plurality of lasers arranged in an array or a two-dimensional array capable of being activated by regions, and the light receiver comprises a two-dimensional array detector, wherein the two-dimensional array detector is configured to select an activated region for detection, and a laser of the lasers or an activated region of the two-dimensional array corresponds to an activated region of the two-dimensional array detector.

25. (canceled)

26. A LiDAR, comprising:
a housing provided with a window; and
the optical scanner system of claim 1, wherein the optical scanner system is arranged in the housing, and the window is configured to transmit the detection laser and the echo.

27. The LiDAR of claim 26, further comprising a base, wherein the housing is fixedly connected to the base, to form a cavity, and the optical scanner system is arranged in the cavity.

28. The LiDAR of claim 26, wherein the window is arranged on a side of the housing close to the scanner.

29. The LiDAR of claim 26, wherein the window is obliquely crossed with a main optical axis of the detection laser.
